(19) United States
(12) Patent Application Publication
(10) Pub. No.: US 2025/0157807 A1
(43) Pub. Date: May 15, 2025

(54) ABLATION DEVICE

(71) Applicant: GEOMAR Helmholtz Centre for Ocean Research Kiel, Kiel (DE)

(72) Inventor: Jan FIETZKE, Rosenfeld (DE)

(21) Appl. No.: 18/920,553

(22) Filed: Oct. 18, 2024

(30) Foreign Application Priority Data
Oct. 20, 2023 (DE) 20 2023 106 081.1

(51) Int. Cl. H01J 49/04; H01J 49/00; H01J 49/10; H01J 49/24

(52) U.S. Cl. CPC H01J 49/0463; H01J 49/0031; H01J 49/105; H01J 49/24

(57) ABSTRACT

An arrangement for analyzing solids includes a laser ablation chamber, a gas flow vacuum pump, and cell and mixed gas feeds. The pump has a first sample gas tube, second mixed gas tube, nozzle, and expansion chamber. The pump is downstream of the ablation chamber. The first tube starts from the ablation chamber. The first tube terminates at the nozzle at the transition to the expansion chamber. The second tube terminates at the expansion chamber. The ablation chamber is operated at a negative pressure. In the ablation chamber, a primary ablation plasma is formed from a sample and condensed to form an aerosol and, together with the cell gas, form the sample gas. Due to the flow of the mixed gas in the second tube, the pump also carries along sample gas in the first tube. The sample and mixed gases are combined in the expansion chamber before analysis.

The entire content of the priority application DE 20 2023 106 081.1 (utility model) is hereby incorporated in the present application by reference.

The invention relates to an ablation device for laser ablation for the analysis of solids. The invention further extends to an ablation chamber gas flow vacuum pump arrangement comprising an ablation chamber for use with a laser, a gas flow vacuum pump, a gas feed for cell gas, in particular a feedback controllable gas feed for cell gas, and a gas feed for mixed gas, in particular a feedback controllable gas feed for mixed gas. The arrangement can also have a pressure measuring device.

Laser ablation for the analysis of solids is an established method. Originally developed by (geo) chemists in order to analyze rock samples directly, it has spread dynamically, over the years, to other fields of research, from geochemistry to materials science and to medical research. In particular, the combination of a high spatial resolution (down to a few μm) and a high detection strength (<μg/g) for many elements and even direct analyses of isotopes with a precision in the region of per mille make it a versatile analysis method with a high performance.

For laser ablation, a sample is typically bombarded with a laser in an ablation chamber or also in a sample chamber in a controlled manner. The sample material which is mobilized as a result of this forms a primary ablation plasma (pAP, also referred to as a “plasma plume”), which, during the expansion, cools down in the ablation chamber and condenses into an aerosol. This aerosol is transported from the ablation chamber to the actual analyzing device (for example ICP-MS or ICP-OES) with the aid of the cell gas, as it is referred to. The cell gas is an inert gas, typically helium (rarely argon), in order to prevent chemical reactions with the sample material.

The construction of laser ablation devices for the analysis of solids and of detection devices for samples in a gas stream by laser ablation is generally known from the state of the art.

For example, a spark emission particle detector is known from DE 11 2011 103 405 T5, in which a particle aerosol is transported from the location of a sample to a detection location, whereby a sample gas is supplied and/or is removed using a pump.

A laser ablation cell is known from U.S. Pat. No. 9,496,124 B2, in which a cell geometry and the flow patterns resulting therefrom are improved in order to reduce washout times for the particles. Ablation in helium is conventionally carried out under normal pressure.

The inventor has recognized that there is currently no commercial system in which active pumping of a mixture of sample aerosol and cell gas from the ablation chamber is used, as corresponding (mechanical) pumps would constitute a particle trap, which means that they would cause a loss of sample material and carryover of sample material. Therefore, it is current practice to always operate the ablation chamber actively with an external gas feed for the sample gas, which can freely flow to the outlet of the chamber. Since the outlet side is operated under atmospheric pressure (for example when there is a connection to an ICP ion source), pressure conditions are created in the interior of the ablation chamber that are slightly above atmospheric pressure (“soft over-pressure”).

Practice shows that a number of parameters have an impact on the quality of the analyses, parameters that relate to the formation of the primary ablation plasma, the condensation of the aerosol, as well as its transportation. As the primary ablation plasma inside the ablation chamber has to work against the pressure of the cell gas during its expansion/cooling/condensation, the choice of cell gas, for example, has a decisive influence on the plasma-condensate transformation process. In practice, it has been observed that, when helium is used as the cell gas, the spatial expansion of the primary ablation plasma is greater than with argon, that fewer large aerosol particles are formed during the condensation and, as a result, less material is deposited on the sample surface. Further, the formation of a finer aerosol leads to less elemental fractionation within the aerosol particles and facilitates a complete thermal decomposition of the sample aerosol in the ICP plasma.

The reason for the differences between helium and argon should primarily be due to their respective densities (approx. 0.18 kg/m³ for helium as opposed to approx. 1.8 kg/m³ for argon). Due to its approximately 10 times higher density, argon puts up a much greater resistance to the expansion of the primary ablation plasma, thus hindering the rapid expansion and leading to condensation from an even denser plasma. The latter leads to the increased formation of larger condensate particles with stronger internal chemical zoning (elemental fractionation), which are more difficult to transport (particle fractionation during transport), which deposit in greater quantities on the sample surface and which are more difficult to decompose in the remaining transportable aerosol in the ICP source (elemental fractionation).

Even when helium is being used (which, additionally generates considerable costs during operation), it is not possible to eliminate completely the effects described here.

The article “High efficiency aerosol dispersion cell for laser ablation-ICP-MS” by J. Pisonero, D. Fliegel and D. Gunther, Journal of Analytical Atomic Spectrometry, the contents of which were published on Aug. 3, 2006, discloses an ablation chamber which is essentially subdivided into a first and a second partial chamber, with a sample being located in the first partial chamber. Cell gas which is supplied to the first partial chamber, together with detached sample material, can get into the second partial chamber via a small opening which leads to an analyzing device. The pressure in the second partial chamber is slightly reduced with respect to the pressure in the first partial chamber, more precisely by less than 100 mbar. In the arrangement disclosed in this article, it can be assumed that, due to the cell gas which is supplied to the first partial chamber, the pressure in the first partial chamber or in the ablation chamber as a whole is at an absolute pressure which is (possibly slightly) above atmospheric pressure. The problems described above then arise, in particular when argon is being used.

It is an object of the present invention to provide an alternative ablation device, in particular an ablation device which eliminates or at least mitigates the known deficiencies of the state of the art.

This object is solved with an ablation chamber gas flow vacuum pump arrangement and a method in accordance with the independent claims.

Also disclosed is a negative pressure ablation chamber gas flow vacuum pump arrangement for laser ablation for the analysis of solids, which comprises the following:
an ablation chamber with a laser;
a gas flow vacuum pump;
a feedback controllable gas feed for cell gas;
a feedback controllable gas feed for mixed gas; and
a pressure measuring device.
   wherein
the gas flow vacuum pump has an inner tube for sample gas, an outer tube for mixed gas, a nozzle and an expansion chamber;
in the direction of gas flow, the gas flow vacuum pump is arranged downstream of the ablation chamber;
the inner tube is arranged starting from the ablation chamber;
the outer tube is joined onto the inner tube at a location downstream of the ablation chamber and upstream of the expansion chamber and is arranged concentrically around the inner tube;
the inner tube is arranged so as to terminate at the nozzle at the transition to the expansion chamber, and the outer tube is arranged so as to terminate in the expansion chamber;
the feedback controllable gas feeds and the pressure measuring device are constructed for monitoring and feedback controlling the operating conditions in the ablation chamber, wherein the ablation chamber is operated at a negative pressure;
   wherein,
in the ablation chamber, a primary ablation plasma is formed from a sample and condensed to form an aerosol and, together with the cell gas, forms the sample gas;
due to high flow velocities of the mixed gas in the outer tube, the gas flow vacuum pump also carries along, from the ablation chamber and via the nozzle, sample gas which is in the inner tube, and
the sample gas and the mixed gas are combined in the expansion chamber before being guided to an analysis.

Through the use of a gas flow vacuum pump, it becomes possible to provide an arrangement that allows active pumping of the sample aerosol/cell gas mixture from the ablation chamber without a particle trap being formed.

In addition, by lowering the pressure in the ablation chamber, the conditions for the expansion of the ablation plasma in the sample chamber can be improved.

Finally, the construction of the ablation chamber, the detection sensitivity of the sample analysis and the use of substances required for operation can be improved.

In particular, the analysis can take the form of a mass spectrometry with an inductively coupled plasma (ICP-MS).

In a preferred embodiment, the feedback controllable gas feeds can also be constructed as mass flow feedback controllers.

Inert gases are used as the cell gas and the mixed gas. In particular, helium or argon can be used as the cell gas, and argon in particular can be used as the mixed gas.

In the ablation chamber, a negative pressure of (significantly) below 1 bar, i.e. <1 bar or <<1 bar, can be established, in particular during operation, whereby this can correspond in particular to an absolute pressure of ≤0.9 bar and/or ≤0.75 bar and/or ≤0.6 bar and/or ≤0.2 bar.

A possible method of operation for a negative pressure ablation chamber gas flow vacuum pump arrangement in accordance with the invention can comprise at least the following steps:
inflow of cell gas feedback controlled by a mass flow feedback controller into the ablation chamber;
bombardment of sample material located in the ablation chamber with laser beams through the cell window of the ablation chamber and formation of a primary ablation plasma and subsequent expansion and condensation to an aerosol;
formation of a sample gas from cell gas and aerosol and entry of sample gas into the inner tube of the gas flow vacuum pump;
inflow of mixed gas feedback controlled via a mass flow feedback controller into the outer tube;
due to high flow velocities of the mixed gas in the outer tube of the gas flow vacuum pump, sample gas which is in the inner tube of the gas flow vacuum pump is also carried along from the ablation chamber and via the nozzle;
combining the sample gas and mixed gas in the expansion chamber of the gas flow vacuum pump before they are being guided to an analysis and
monitoring the pressure in the ablation chamber via a pressure measuring device, whereby the ablation chamber is operated at a negative pressure, and an adjustment and control is carried out via the mass flow feedback controllers of the cell gas and the mixed gas.

By a (significant) reduction of the pressure in the ablation chamber—at least below atmospheric pressure—the conditions for the expansion of the primary ablation plasma in the ablation chamber can be improved or optimized and the problems described above can be reduced or minimized. As has already been mentioned above, this has not yet been applied in practice, as active pumps usually include mechanical components that retain condensate/sample aerosol and thus result in carryover of condensate/sample aerosol or make condensate/sample aerosol unusable.

In accordance with the present invention, the sample gas is removed from the ablation chamber via a gas flow vacuum pump with a pump nozzle. Such a pump is comparable, for example, to a water jet pump or also a Venturi pump or even a conventional sample atomizer for ICP. In such a pump, due to the high flow velocities in, for example, an outer tube, gas from a tube which is, for example, arranged concentrically in the outer tube, is also carried along.

This arrangement and this method can easily be implemented in existing measuring arrangements in particular, since additional mixed gas, in particular argon, is added anyway to the cell gas that is being used, before the gas is fed into the ICP source. By choice of a suitable geometry of the two concentric tubes (Venturi nozzle) an effective and efficient pump is created for the sample gas from the ablation chamber, which pump also does not have the typical disadvantages of mechanical pumps. The geometry and flow velocity in the outer tube (operated with mixed gas) define the pumping capacity, which, due to the controlled gas feed into the ablation chamber, results in a pressure inside the chamber that is well below atmospheric pressure. Despite the low pressure inside the chamber, the resulting total gas flow can still be connected to the ICP source (under atmospheric pressure) without any problems.

In addition to arrangements with an outer tube and a concentrically arranged inner tube, other tube arrangements are also possible. In general, tube arrangements can be used in which a gas which is located in a first tube—in this case, this is the sample gas from the ablation chamber—is also carried along by the flow of a gas in a second tube—in this case, this is a mixed gas that is being supplied. In this context, the flow velocity of the gas in the second tube is higher than the flow velocity of the gas in the first tube. Essentially, the following applies: The higher the flow velocity of the gas in the second tube, the greater the pressure reductions that can be achieved in the first tube.

For the purpose of monitoring and feedback controlling the vacuum operation of the ablation chamber, the ablation chamber can have a pressure measuring device and an adjustable gas feed. From a technical point of view, the latter is typically implemented via a mass flow feedback controller (MFC), as it is referred to. However, embodiments are also possible in which the gas feed (cell gas and/or mixed gas) is not feedback controllable and/or in which there is no pressure measuring device for the ablation chamber. For example, the tube diameters of the tubes which are used for the gas feed and, if applicable, further parameters of the arrangement can be selected in such a way that a (suitable) negative pressure compared to atmospheric pressure is created in the ablation chamber.

In dependence upon the pressure reduction achieved, it is possible to significantly further improve the expansion capacity of the primary ablation plasma in helium operation, or that a behavior of the primary ablation plasma can be achieved that corresponds to helium operation at “soft over-pressure” even when operating the ablation chamber with argon as the cell gas. Both of these result in an improvement in the analytical performance and, on top of that, also results in cost savings (as regards helium).

With the negative pressure ablation chamber gas flow vacuum pump arrangement in accordance with the invention, it becomes possible to carry out ablation of a sample of solid material under lower pressure, which causes expansion of the primary ablation plasma to be facilitated and thus brings about a condensation into a finer aerosol. This in turn results in increased transport efficiency and sample yield and leads to less elemental fractionation within the aerosol particles and facilitates a complete thermal decomposition of the sample aerosol in the ICP plasma.

The ablation chamber can have a sample holder which is set up to hold the sample in such a way that, when the arrangement is used in accordance with its intended use, a laser beam which emanates from the laser to be used with the arrangement hits a surface portion of the sample to which a surface normal is assigned which is oriented away from the sample and which has a directional component which, in relation to the direction of gravity, is directed downwards. For example, the sample holder can hold the sample in the ablation chamber in such a way that a surface which the laser beam is supposed to hit is oriented downwards. In this context, this surface does not have to be horizontal (in relation to gravity), but can be tilted by an acute angle other than 0° with respect to a horizontal plane. This makes it possible to additionally utilize gravity for the transport of sample material which has been detached from the sample by the laser beam. The sample material which has been detached, or the aerosol, is then transported in the direction of the analyzing device not only by the negative pressure which is generated by the gas flow vacuum pump, but gravity can also support this transport.

In the present case, the term “use in accordance with its intended use” is to be understood to mean, in particular, an intended orientation of the arrangement, or at least of the ablation chamber. For example, if the arrangement or the ablation chamber has a base surface or support legs or rubber feet or the like that normally (should) point downwards, this can define the intended orientation.

A surface in the mathematical sense always has two surface normals, i.e. two spatial vectors which point in opposite directions and which are perpendicular to the surface. In the present arrangement, the term “surface normal which is oriented away from the sample” refers to only one of these spatial vectors, i.e. the one pointing into the largely empty space of the ablation chamber and not the one pointing into the sample.

In the mathematical sense, a surface normal is always related to a surface point. In dependence upon the surface structure of a real sample, the surface normals, which are assigned to surface points that are close to one another, may possibly be oriented in significantly different directions. In the present case, the “surface” which the surface normal mentioned above should be perpendicular to can therefore, if applicable, be considered to be a (flat) surface that turns out to be the “best fit” over a surface area of the sample, for example a circular surface area of the sample, which has a diameter of approx. 1 mm or a few millimeters, for example 2 mm, 3 mm, 4 mm or 5 mm.

In the following, the invention is described with reference to the accompanying schematic figures in the specific description, whereby these are intended to explain the invention and are not necessarily to be regarded as limiting.

In the figures:

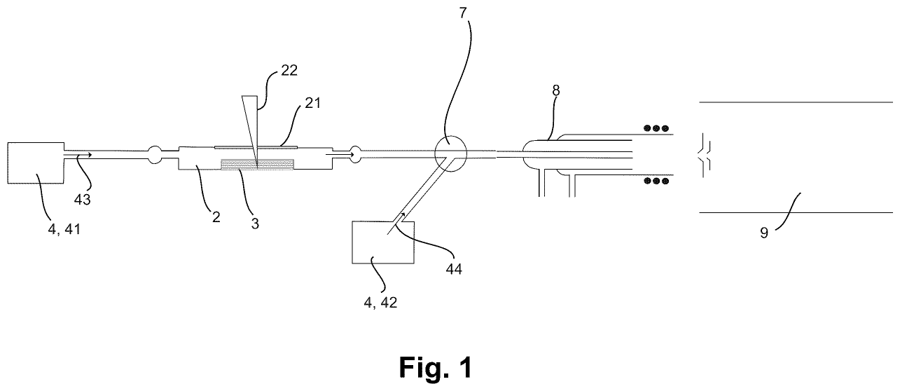

FIG. 1 shows, by way of example, a representation of an embodiment of an arrangement for laser ablation in accordance with the state of the art,

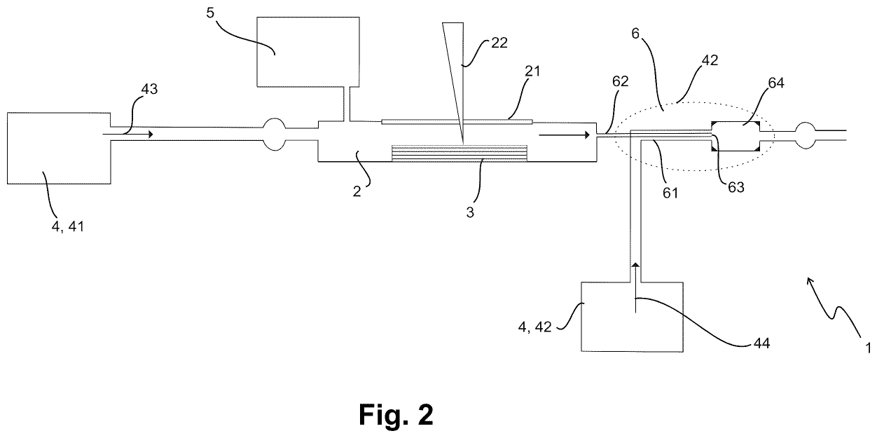

FIG. 2 shows, by way of example, a representation of an embodiment of a negative pressure ablation chamber gas flow vacuum pump arrangement in accordance with the invention, and

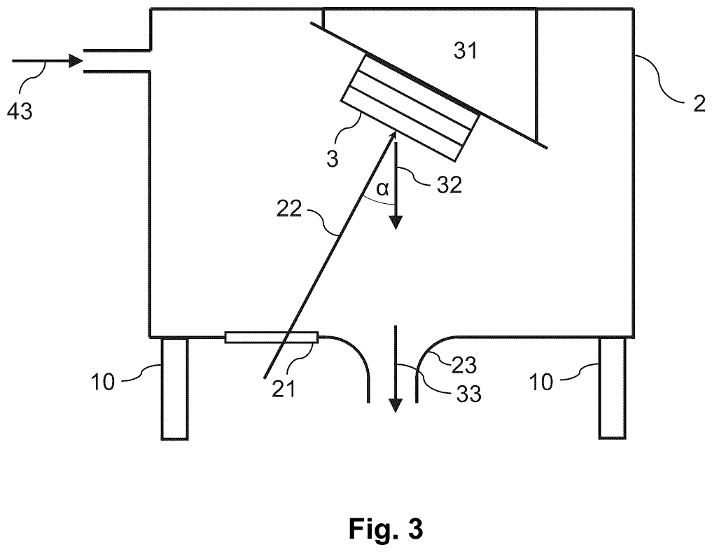

FIG. 3 shows, by way of example, a representation of an embodiment of an ablation chamber of a negative pressure ablation chamber gas flow vacuum pump arrangement in accordance with the invention.

FIG. 1 shows, by way of example, a representation of an embodiment of an arrangement for laser ablation in accordance with the state of the art. Cell gas 43 is introduced into an ablation chamber 2 via a feedback controllable gas feed 41 for cell gas. A sample 3 is located in the ablation chamber 2, which sample 3 is bombarded with a laser beam 22 through a cell window 21. A primary ablation plasma is formed through the laser bombardment of the sample 3. The primary ablation plasma condenses into an aerosol in the ablation chamber 2. The aerosol is transported together with the cell gas 43 to a plasma ion source 8 with a mass spectrometer 9 located downstream. During the transport, mixed gas 44 is fed, via a connecting piece 7, to the cell gas 43 containing the aerosol before the plasma ion source located downstream is reached.

Active pumping, from the ablation chamber 2, of the cell gas 43 (sample gas) containing aerosol does not take place. To date, mechanical pumps which could be used for this purpose represent a particle trap, i.e. loss of sample material and carryover of sample material. According to the state of the art, it is common practice to actively supply the ablation chamber with an external gas feed (cell gas), in which the sample gas flows freely to the exit of the ablation chamber. As the outlet side is operated under atmospheric pressure, for example when connected to an ICP ion source located downstream, pressure conditions are created inside the ablation chamber that are slightly above atmospheric pressure. This is also referred to as “soft over-pressure”.

FIG. 2 shows, by way of example, a representation of an embodiment of a negative pressure ablation chamber gas flow vacuum pump arrangement 1 in accordance with the invention. Cell gas 43 is fed into an ablation chamber 2 via a feedback controllable gas feed 41. A sample 3 is located in the ablation chamber, which sample 3 is bombarded with a laser beam 22 through a cell window 21, so that a primary ablation plasma is formed. This primary ablation plasma then condenses into an aerosol during expansion. A gas flow vacuum pump 6 is located downstream of the ablation chamber 2 in the direction of gas flow. An inner tube 62 of the gas flow vacuum pump 6 is arranged starting from the ablation chamber 2. An outer tube 61 of the gas flow vacuum pump 6 is joined onto the inner tube 62 downstream of the ablation chamber 2 and upstream of the expansion chamber 64 and is arranged concentrically around the inner tube 62. Due to high flow velocities of the mixed gas 44 in the outer tube 61, the gas flow vacuum pump 6 also carries along, from the ablation chamber 2 and via the nozzle 63, sample gas which is in the inner tube 62. The sample gas and the mixed gas 44 are combined in the expansion chamber 64 of the gas flow vacuum pump 6 before being guided to an analysis. The pressure in the ablation chamber 2 is monitored via a pressure measuring device 5. Monitoring and feedback controlling of the operating pressure in the ablation chamber 2 takes place via the feedback controllable gas feeds 41, 42 in combination with the pressure measuring device 5, whereby the ablation chamber 2 is operated at a negative pressure.

FIG. 3 shows, by way of example, a representation of an embodiment of an ablation chamber 2 of a negative pressure ablation chamber gas flow vacuum pump arrangement 1 in accordance with the invention. The ablation chamber 2 shown in FIG. 3 is based, in principle, on the ablation chamber 2 of FIG. 2. The pressure measuring device 5 shown in FIG. 2 is not shown in FIG. 3. Cell gas 43 flows into the ablation chamber 2 via an inlet as shown in FIG. 2.

In the embodiment in accordance with FIG. 3, support legs 10 are attached to the underside of the ablation chamber 2. When the arrangement is used in accordance with its intended use, these support legs 10 point downwards. In contrast to FIG. 2, the sample 3 is not arranged in the lower region of the ablation chamber 2, but in the upper region. For this purpose, the sample 3 is held by a sample holder 31. The lower surface of the sample holder 31, on which the sample 3 is arranged, is inclined with respect to a horizontal. In the case of a sample 3 with substantially parallel main surfaces, for example a cuboid sample 3, a main surface of the sample 3 or a surface region of this sample 3 which is to be hit by the laser beam 22 is therefore also inclined with respect to a horizontal, but, in general, points downwards.

In accordance with FIG. 3, the cell window 21 is arranged in a lower wall of the ablation chamber 2. The laser beam 22 can hit the sample 3 through this cell window 21. In order to release sample material, the laser beam 22 thus hits a surface of the sample 3 which surface is generally downwardly directed. The laser beam 22 hits the surface of the sample 3 substantially vertically.

The direction of the laser beam 22 forms an angle α with the direction of gravity 32. This angle α can in principle be between 0° and 90°, although an angle which is different from 0° is preferred, for example in the range from 10° to 80°. The angle α can, for example, be greater than or equal to a minimum angle of 20°, 30°, 40°, 45°, 50° or 60° and/or smaller than, or equal to, a maximum angle of 70°, 60°, 50°, 45°, 40° or 30°.

Since the surface portion of the sample 3 which the laser beam 22 is intended to hit generally points downwards, sample material which has been detached from the sample 3 is transported downwards, i.e. away from the sample 3, also using the force of gravity 32. In this way, sample material that has already been detached can, if applicable, be prevented from accumulating on the sample surface. In addition, the yield of sample material that can be fed to the downstream analyzing device (not shown in FIG. 3) can be increased in this way, if applicable.

As has been described in connection with FIG. 2, the sample material which has been detached from the sample 3 also forms an aerosol 33, in accordance with FIG. 3, which aerosol 33 is fed to the analyzing device in particular by the gas flow vacuum pump 6 (not shown in FIG. 3). In order to further support the transport of the aerosol 33 to the analyzing device, the outlet 23 from the ablation chamber 2 provided for the aerosol 33 can be arranged in the lower wall of the ablation chamber 2, as it is shown in FIG. 3. In particular, this outlet 23 can be arranged below the point of the sample 3 which is to be hit by the laser beam 22. In particular, when viewed in projection from above (along the direction of gravity 32), the point of the sample 3 which is to be hit by the laser beam 22 may lie within the cross-section of the outlet for the aerosol 33, as is the case in FIG. 3. Alternatively, the outlet 23 for the aerosol 33 can also be located at a different position on the wall of the ablation chamber 2, i.e. also for example on a side wall.

An angle α of 0° between the laser beam 22 and the direction of gravity 32 is not preferred, among other reasons because sample material which has been detached from the sample 3, if it moves vertically downwards, in particular due to gravity 32, could at least partially block the laser beam 22 and could also accumulate on the cell window 21.

In the example shown in FIG. 3, the outlet 23 for the aerosol 33 has the shape of a funnel 23. The cross-section of the outlet 23 can decrease linearly starting at the ablation chamber 2—an approximately triangular shape would result in a view from the side. Alternatively, the cross-section of the outlet 23 can also decrease in a different way, for example in the way that is shown in FIG. 3—in a view from the side, the shape of the funnel 23 follows a quarter circle in this example. Other shapes are also possible. A decreasing cross-section in the funnel 23 causes the flow velocity of the aerosol 33 in this funnel 23 to increase and, as a result of this, the probability of aerosol particles settling on the walls is reduced.

Embodiments without a funnel are also possible and may allow a simpler construction. In this case, a tube with a constant cross-section can be connected directly to the ablation chamber 2 in order to form an outlet 23.

While at least one example embodiment has been described above, it is to be noted that a large number of variations thereto exist. In this context it is also to be noted that the example embodiments described herein only represent non-limiting examples, and that it is not intended thereby to limit the scope, the applicability, or the configuration of the devices and methods described herein. Rather, the preceding description will provide the person skilled in the art with instructions for the implementation of at least one example embodiment, whereby it is to be understood that various changes in the functionality and the arrangement of the elements described in an example embodiment can be made without thereby deviating from the subject matter respectively set forth in the appended claims as well as legal equivalents to this subject matter. Each of the features which are described herein can be combined with each other as desired, as long as this is not expressly excluded or technically impossible. Likewise, the features which are described predominantly in connection with one aspect disclosed herein or in connection with one embodiment disclosed herein may correspondingly constitute features of the other aspects or embodiments disclosed herein. In addition, all aspects and features which are disclosed herein are to be regarded as aspects of the present invention, either in isolation or in combination.

### LIST OF REFERENCE SIGNS

1 negative pressure ablation chamber gas flow vacuum pump arrangement
2 ablation chamber/ablation cell
21 cell window
22 laser beam
23 outlet, funnel
3 sample
31 sample holder
32 (direction of) gravity
33 sample material, aerosol
4 feedback controllable gas feed (line), mass flow feedback controller
41 feedback controllable gas feed (line) for cell gas
42 feedback controllable gas feed (line) for mixed gas
43 cell gas
44 mixed gas
5 pressure measuring device
6 gas flow vacuum pump
61 outer tube for mixed gas flow
62 inner tube for sample gas flow
63 nozzle
64 expansion chamber
7 connecting piece for combining sample gas and mixed gas
8 plasma ion source (ICP)
9 mass spectrometer
10 support legs

1. An ablation chamber gas flow vacuum pump arrangement for laser ablation for analysis of solids, comprising:
an ablation chamber for use with a laser;
a gas flow vacuum pump;
a gas feed for cell gas; and
a gas feed for mixed gas,
wherein:
the gas flow vacuum pump has a first tube for sample gas, a second tube for mixed gas, a nozzle, and an expansion chamber;
in the direction of gas flow, the gas flow vacuum pump is arranged downstream of the ablation chamber;
the first tube is arranged starting from the ablation chamber;
the first tube is arranged so as to terminate at the nozzle at the transition to the expansion chamber;
the second tube is arranged so as to terminate at the expansion chamber;
the gas feed for cell gas, the gas feed for mixed gas, and the gas flow vacuum pump are configured so that the ablation chamber is operated at a negative pressure with respect to atmospheric pressure;
wherein the ablation chamber gas flow vacuum pump arrangement is set up so that in operation:
in the ablation chamber, a primary ablation plasma is formed from a sample and condensed to form an aerosol and, together with the cell gas, forms the sample gas;
due to the flow of the mixed gas in the second tube, the gas flow vacuum pump also carries along, from the ablation chamber and via the nozzle, sample gas which is in the first tube, and
the sample gas and the mixed gas are combined in the expansion chamber before being guided to an analysis.

2. The arrangement according to claim 1, wherein:
the arrangement further comprises a pressure measuring device, and the gas feed for cell gas and the gas feed for mixed gas are feedback controllable, and
the gas feed for cell gas, the gas feed for mixed gas, and the pressure measuring device are constructed to facilitate monitoring and feedback controlling the operating conditions in the ablation chamber in order to operate the ablation chamber at the negative pressure.

3. The arrangement according to claim 1, wherein the first tube is an inner tube and the second tube is an outer tube, the outer tube being is joined onto the inner at a location downstream of the ablation chamber and upstream of the expansion chamber and being arranged around the inner tube.

4. The arrangement according to claim 1, wherein the analysis includes mass spectrometry with an inductively coupled plasma (ICP-MS).

5. The arrangement according to claim 1, wherein the gas feed for cell gas and the gas feed for mixed gas are mass flow controllers.

6. The arrangement according to claim 1, wherein helium or argon is used as the cell gas.

7. The arrangement according to claim 1, wherein argon is used as the mixed gas.

8. The arrangement according to claim 1 wherein the ablation chamber gas flow vacuum pump arrangement is set up in such a way that, during operation, a negative pressure corresponding to an absolute pressure of ≤0.9 bar or ≤0.8 bar or ≤0.75 bar or ≤0.7 bar or ≤0.6 bar or ≤0.5 bar or ≤0.4 bar or ≤0.3 bar or ≤0.2 bar, is established in the ablation chamber.

9. The arrangement according to claim 1, wherein the ablation chamber has a sample holder configured to hold the sample so that, when the arrangement is used in accordance with its intended use, a laser beam that emanates from the laser to be used with the arrangement hits a surface portion of the sample to which a surface normal is assigned which is oriented away from the sample and which has a directional component which, in relation to the direction of gravity, is directed downwards.

10. The arrangement according to claim 1, wherein the ablation chamber has an outlet for the aerosol, the outlet, when the arrangement is used in accordance with its intended use, lies below the surface portion of the sample which is to be hit by the laser beam, so that, when viewed in projection from above along the direction of gravity, the surface portion of the sample that is to be hit by the laser beam lies within the cross-section of the outlet for the aerosol.

11. The arrangement according to claim 10, wherein the outlet has a funnel shape.

12. A method of carrying out laser ablation for the analysis of solids using an arrangement according to claim 1, wherein the ablation chamber is operated at a negative pressure corresponding to an absolute pressure of ≤0.9 bar or ≤0.8 bar or ≤0.75 bar or ≤0.7 bar or ≤0.6 bar or ≤0.5 bar or ≤0.4 bar or ≤0.3 bar or ≤0.2 bar.

13. The method according to claim 12, wherein argon is used as the cell gas.

14. The arrangement according to claim 1, wherein the ablation chamber includes a laser.

15. The arrangement according to claim 3, wherein the outer tube is arranged concentrically around the inner tube.
